(19) United States
(12) Patent Application Publication
(10) Pub. No.: US 2003/0140061 A1
(43) Pub. Date: Jul. 24, 2003

(54) Process for linking print and online media and storing information electronically

(76) Inventor: Zachary Byron Singer, Scarsdale, NY (US)

Correspondence Address: Zachary Byron Singer, 38 Greenacres Avenue, Scarsdale, NY, 10583-1414, US

(21) Appl. No.: 10/057,494

(22) Filed: Jan. 24, 2002

(51) Int. Cl. G06F 17/00; G06F 7/00

(52) U.S. Cl. 707/104.1

(57) ABSTRACT

There is disclosed a process for linking print and online media and storing information electronically. The process employs an alphanumeric code that publishers will assign to their articles. Each code is printed on each article so that it is visible to the reader. Publishers log onto a network and receive the alphanumeric code and enter the URL that corresponds to an online copy of the appropriate (“coded”) article. The process then copies the article to local storage and adds an article record to the article table in the relational database management system (“RDMS”).

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING, TABLE, OR COMPUTER PROGRAM LISTING APPENDIX

Not Applicable

### BACKGROUND OF THE INVENTION

So far, Internet media has generally been unprofitable for both “pure” Internet publications (e.g., Slate, Salon, and Snowball) and for traditional publishers such as The New York Times and The Wall Street Journal. Online readers will rarely pay for online content. Print subscribers rarely read print content online.

Traditional print publishers worry that their Internet content will cannibalize their print sales. As a result they price individual online articles at prices that are just below the entire printed publication's price.

Content sites often force users to register so that publishers can then send targeted advertisements or set up billing accounts. The most valuable readers, those who read many publications, avoid publisher websites because they detest tedious registration forms. As a result publisher websites are under-exploited.

It is often difficult to “re-find” pages on the Internet. Link navigation is tedious, time consuming and search engines, programs that use keywords to find information, often churn out hundreds of irrelevant links.

Moreover, users become infuriated when an online article, read months, weeks or even days earlier, cannot be found. Book-marking URLs does not help because websites often move, delete or change the file.

Print publishers have few tools to determine which print article readers find useful and have no idea which print articles are clipped. Online publishers don't know if someone read an article carefully or if he glanced at it and hit the “back” button.

Readers store paper articles because it is difficult to scan a paper article into the computer. Readers often print Internet articles because web site managers often move or delete content. Keeping files up-to-date can mean coping with easily lost mountains of paper.

Clipping print articles is problematic; paper publications often have useful articles on both sides. People who share publications resent it when articles are cut out before they can read them.

Photocopying articles is cumbersome and time consuming, especially when dealing with irregularly sized or colored newspaper articles. The Financial Times, for example, is salmon colored and photocopies poorly.

Reorganizing files, or integrating many users files, becomes more complex and time consuming as the number of articles grows, since it requires going through all filed articles and reclassifying—a painful endeavor. Classifying one article in many folders means making many copies because one piece of paper can only be in one folder at a time.

Sharing paper clippings is difficult, faxing or mailing articles is time consuming and searching through someone else's paper files requires learning their classification system.

Lastly, paper files often contain less information than their online counterparts because printing online articles destroys the links (URLs) to additional information. For example, a screen might read, “Click here for more information,” but a paper printout loses this link.

Therefore, there is a need in the art to find ways to improve the filing of online and printed articles such that they can be easily indexed and retrieved. The present invention addresses this need.

### BRIEF SUMMARY OF THE INVENTION

The present invention provides a process for storing and accessing information from publisher's server storage electronically, comprised of the following:

(a) providing each media article with an alphanumeric code having regions in the code for publication source, publication date, article identification;

(b) caching each article using the code as a local file identifier in a relational database management system (RDMS) table; and

(c) associating the code with each article published to allow for retrieval of the article through accessing the table.

Preferably, the alphanumeric code is from about 7 to about 20 digits in length. Preferably, the alphanumeric code is printed or affixed to each article contained in the table. Preferably, the RDMS is arranged to allow for article retrieval by addressing through the article's alphanumeric code. Preferably, each article having the alphanumeric code is identified in a single table and is accessible through a common link.

Preferably, the process further comprises creating a retrieval website that assesses a fee to users for each article accessed from the cache and searched through the alphanumeric code. Most preferably, the process further comprises configuring the retrieval website to provide for targeted advertising. Most preferably, the retrieval website tracks articles accessed to provide for a copyright fee to each publisher whose article was copied, from the fee charged to the user.

The present invention provides a process for linking print and online media and storing information electronically, comprised of the following:

(a) assigning an alphanumeric code to every article and matching that code in a lookup table with a specific locally stored file containing an electronic version of the article;

(b) printing each alphanumeric code next to the appropriate article in the printed publication;

(c) allowing a user to enter the nine-digit alphanumeric code into a lookup table query, wherein the query returns the article from a stored cache;

(d) storing article identifiers electronically in a master table;

(e) maintaining a list of those articles in the personal tables of users who requested it;

(e) creating a transaction clearinghouse table that allows users to get licensed content without registering at many different publishers sites;

(f) creating a master article table that allows for targeted advertising, and efficient storage;

(g) allowing for the creation of such statistics as are needed to determine which articles are clipped from which types of users; and

(h) allowing for a central transaction clearinghouse for articles that will collect money from users and then, after taking a fee, compensate the original publishers—by which method users can avoid registering at many different web sites.

### BRIEF DESCRIPTION OF DRAWINGS

Not Applicable

### DETAILED DESCRIPTION OF THE INVENTION

The present invention provides a process for linking print and online media and storing information electronically.

The process includes a unique article coding process and six RDMS tables:

1. A publisher table that identifies the publishers and related information

2. A publication table that identifies the publications and related information.

3. A master article table that identifies the articles and related information.

4. A user table that identifies the users and related information.

5. A user's clippings table that identifies the articles that a user clips.

6. A transaction table that logs article retrieval and related information.

Technical Field of the Invention

The present invention provides a process for linking print and online media and storing information electronically. The process employs an alphanumeric code that publishers will assign to their articles. Each code is printed on each article so that it is visible to the reader. Publishers log onto a network and receive the alphanumeric code and enter the URL that corresponds to an online copy of the appropriate (“coded”) article. The article is copied to a local storage and is added as an article record to the article table in the relational database management system (“RDMS”). Users can then log onto a different screen and enter that article's code, whereupon the corresponding article is retrieved. The article can then be clipped into the users personal table.

The Coding Process—The Fundamental Element

The inventive process employs an alphanumeric code (numbers 0-9, letters a-z), preferably a nine-digit alphanumeric code, that publishers assign to print articles. Publishers and users see a nine-digit code such as “NYT00a012”. Each code is printed on each paper article and is visible to the reader.

The alphanumeric code divides into three parts. Using an example of a nine-digit alphanumeric code, each external part has three characters and contains 46,656 combinations (36 cubed). The nine-character string together contains 101,559,956,668,420 combinations (46,656 cubed). The first three digits denote a specific publication, such as a magazine or newspaper. There are 46,656 possible combinations, and every participating magazine and newspaper would be assigned at least one. The second three digits denote the date of the publication by counting the number of days from a specific date. With 46,656 possible combinations, a daily publication can be coded for approximately 127 years. The last three digits denote an individual article and provide for a maximum of 46,656 articles per publication per day.

To optimize table efficiency, the process represents the code internally as a twelve-digit sequence by adding a “0” after every three digits of the nine-digit code. So the “NYTbbb111” seen by the user and the publisher is “NYT0bbb01110” internally. The user types in the nine-digit code found on the paper article and the process internally converts it into the twelve-character version. The code is case insensitive.

The Publisher Table

The publisher table consists essentially of:

1. A unique publisher logon name

2. An alphanumeric logon password

3. A unique publisher identification number

4. Contact information

5. Banking instructions

Publisher Setup

The publisher accesses the process via the Internet. Before using the process for the first time the publisher runs a setup screen on the website. The publisher fills out an HTML form that requests publisher name, billing information, logon name, password, e-mail address and the name of the person at his organization responsible for the encoding. The publisher then submits the data by clicking on the submit button.

The process then does some validity checks including but not limited to searching the publisher table to see if the publisher is already a client and if the billing information exists. If the data is valid the publisher is assigned a unique publisher number. The data is then added as a record to the publisher table.

After completing the setup phase the publisher can add the publications that he wishes to encode to the publications table.

The Publications Table

The publications table consists essentially of:

1. A 3 digit alphanumeric publication identifier chosen by the publisher

2. The unique publisher identification number from the publisher table

3. A unique publication identification number

4. An alphanumeric publication short name

5. An alphanumeric publication long name

The Publications Setup

Before encoding a publication for the first time the publisher must first run the publications setup. To do this the publisher fills out an HTML form that requests the publications desired 3-digit alphanumeric code, the short name of the publication and the long name of the publication. The publisher then submits this data to the process by clicking on the submit button.

The process then does some validity checks, which include, but are not limited to: does the requested 3-digit alphanumeric code already exist? Does the publication already exist? If the data are not valid, which could happen if, for example, the 3-digit code is being used by another publication, then the publisher is asked to make another choice. If the data are valid the publication is assigned a unique 3-digit code and a unique publication identification number. The publication data is then added a record to the publication table.

Once publisher and publication is completed articles can be added to the process.

The Master Article Table

The master article table consists essentially of:

1. An article alphanumeric identification code

2. The unique publisher identification number from the publisher table

3. The unique publication identification number from the publication table

4. A file type (html, pdf, doc, etc . . . )

5. An article headline

6. A price or assessment fee

7. An article keyword classification

8. An advertising keyword classification

Encoding Articles

To encode articles the publisher goes to the process logon web screen. The publisher first identifies himself by entering his unique logon name and password into HTML fields. The process then locates his name and password among the records in the publisher table. Should there be no name match, or if the password is incorrect, the publisher is sent an error message.

Once identified, the publisher chooses which publication to encode. The publisher does this by either entering the 3-digit publication identification code into an HTML field or by selecting from menu containing publication names and the 3-digit publication codes.

After selection the publisher enters the publication date into an HTML field. The date validity is checked, and if valid, calculates the number of days from a pre-selected date and the entered date. The calculated number is converted into a base 36 number that makes up the second part of the code. The base 36 result is represented by the numbers 0-9 and letters a-z inclusive where z, for example, has a numerical value of 35.

The software program directing the process then determines the next unused unique code by constructing a partial table key consisting of the publication and date codes. The process then looks for the first occurrence of this partial key in the article table. If the process gets a successful return—meaning an article was found for this publication and this date, the process increments the search by one and repeats the search until it get a record not found indication. The first unsuccessful return is the next unique unused code.

For example, suppose The New York Times wants to add an article printed on Jan. 2, 2002 to the table. Furthermore, assume that the date from which date increments are calculated is Jan. 1, 2002. Externally, the first part of the code would be “NYT” to represent The New York Times (internally this would be represented as “NYT0”). Externally, the second part of the code would be “002” for the second day of the calendar (internally this would be represented as “0020”). The first article for this publication, on this date, would be externally identified as “NYT002001” (internally the table would represent it as “NYT000200010”). The second article would be externally represented as “NYT002002” (internally “NYT000200020”) and so on. If the NYT wanted to add a new article for Jan. 10, 2002, the code might be externally represented as “NYT00a001” (internally “NYT000A00010”). The letter “a” is 10 in a base 36 number system

Once found, the screen shows the unique article code for that publication and date. Next to the article code are HTML input fields. The first input field is for the online location of the article that is called a Universal Resource Locator or URL. The second field is for the headline of the article. The third input field is for the price of the article. Free articles have a price of zero.

Other fields can be entered. Publishers may enter an article keyword classification for subsequent query retrieval. Publishers may enter codes that can be used to determine which advertising should be shown when users retrieve particular articles.

After the publisher hits the submit button the process copies the article from the publisher's online storage, denoted by the URL, to a local storage disc and simultaneously renames the article using the processes internal method. The process then updates the master table with the new record. The process does not store the article on the publisher's computers—the process copies from publisher server storage to process local storage. If the process cannot copy the article to local storage, the master article table is not updated and the publisher is informed of this problem by error message.

A Note on Article Filenames and File Types

The article is stored in a file where the identifier prefix of the article is the internal twelve-digit code and the suffix equals the file type. For example, if the external code is “NYTbbb111” (internally “NYT0bbb01110”) and the file is an HTML file then the file would be stored on disc as “NYT0bbb01110.html”. The article suffix is stored in the master table so the process can use many file types including “html”, “doc”, and “pdf”.

The User Table

The user table consists essentially of:

1. A logon user name

2. An alphanumeric logon password

3. A user identification number

4. Contact information including name, e-mail, home address

5. Credit card information

User Setup

First time users must go through a setup process where they fill out an HTML form that requests user name, credit card information, a logon name, a password, and an e-mail address. The credit card information is optional as it is only used when the user retrieves articles for which publishers charge. Users who have not entered credit card information are sent back to the setup screen when they try to retrieve articles that have prices. After completing the form the user submits the data by clicking on the submit button.

The process then does validity checks including but not limited to searching the user table to see if the user's requested logon name already exists. If the data is valid the user is assigned a user number and the user data is added as a record in the user table.

User Interaction

After completing setup the user can retrieve publications by first submitting his unique logon name and password in HTML fields. The process then compares his logon name and password to those in the user table. If the logons and password are correct the process displays an “article retrieval” screen. Otherwise the user is sent an error message that logon failed.

The user then enters an article code into an HTML field. The process then calls the table master article table. If the code is not in the table the process sends an “Article not found” message.

If the code exists the process reads the file type for that code (the suffix) from the master article table and builds the article's file identifier via an ASCII character string join.

The article code resides in the leftmost 12 bytes and the file type resides in bytes 14 and to the right. The 13th byte from the left is occupied by a period “.” which separates the two identification components.

The process then checks for the article's price. If the article has a non-zero price and the user has no billing information the process sends the user to the setup screen so that this information can be entered.

The process then adds a transaction record to the transaction table.

The process then retrieves the article by opening up a thread with the file identifier and executing a read statement. The article is then displayed on the users screen.

User Clippings Table

The clippings table consists essentially of:

1. A user identification number from the user table

2. The alphanumeric article identifiers that have been clipped for future retrieval

3. An optional user created keyword

The process lets users clip retrieved article codes for future reference. Users may classify an article by entering a user created keyword into an HTML field prior to “clipping” the article. Keywords relate similar articles so that they can be retrieved together.

Users clip articles by clicking on a “clip” button located above the article. Once clipped an article record is added to the personal user table.

Other screens let users view keywords or display the headlines of the clippings. The headline comes from the records in the master article table. Each displayed headline is a link that, when clicked, tells the process to retrieve and display that article.

The process can also batch print either all of the clipped articles or all of the articles related to a particular keyword. The output of the batch print fits neatly into a loose-leaf folder.

The Transactions Table

The transactions table consists essentially of:

1. The publisher identification number from the publisher table

2. The publication identification number from the publications table

3. The article code identification number from the article table

4. The user identification number from the user table

5. The transaction date

6. The article price from the master article table

7. The retrieval/clipped flag

The process adds a transaction record to the transaction table whenever an article is retrieved or clipped. Publishers use reports from this table to identify their most retrieved or clipped articles, determine which articles their readers find most significant adjust their reporting accordingly and optimize advertisements and related links.

The transaction record notes the date the transaction took place and whether the article was just retrieved or clipped for future review.

The process also uses the transaction log as a clearinghouse to compute how much the users owe the publishers. The monies owed are calculated by summing the transactions. The sum of all of a publisher's transactions is owed to the publisher and the user owes the sum of all of the user's transactions.

1. A process for storing and accessing information from publishers electronically, comprised of the following:
(a) providing each media article with an alphanumeric code having regions in the code for publication source, publication date, article identification;
(b) caching each article using the code as an address in a table; and
(c) associating the code with each article published to allow for retrieval of the article through accessing the table.

2. The process for accessing information from publishers electronically wherein the alphanumeric code is from about 7 to about 20 digits in length.

3. The process for storing and accessing information from publishers electronically wherein the alphanumeric code is printed or affixed to each article contained in the table.

4. The process for retrieving, storing and accessing information from publishers electronically (claim 1) wherein the table is arranged to allow for article retrieval by addressing through the alphanumeric code.

5. The process for storing and accessing information from publishers electronically claim 1 wherein each article having the alphanumeric code is stored in a cache and is accessible through a common link.

6. The process for storing and accessing information from publishers electronically of claim 1 wherein the process further comprises creating a retrieval website that assesses a fee to users for each article accessed from the cache and searched through the alphanumeric code.

7. The process for storing and accessing information from publishers electronically of claim 6 wherein the process further comprises configuring the retrieval website to provide for targeted advertising.

8. The process for storing and accessing information from publishers electronically of claim 6 wherein the retrieval website tracks articles accessed to provide for a copyright fee to each publisher whose article was copied, from the access fee charged to the user.

9. A process for linking print and online media and storing information electronically, comprised of the following:
(a) assigning a nine-digit alphanumeric code to every article and matching that code in the process's table with a specific URL containing an electronic version of the article;
(b) printing each nine-digit code next to the appropriate article in the printed publication;
(c) allowing a user to enter the nine-digit alphanumeric code into a table query, wherein the query returns the article from a stored cache, thereby the system;
(d) storing articles electronically in a master table;
(e) maintaining a list of those articles in the personal tables of users who requested it;
(e) creating a transaction clearinghouse table that allows users to get licensed content without registering at many different publishers sites;
(f) creating a master content table that allows for targeted advertising, and efficient storage;
(g) allowing for the creation of such statistics as are needed to determine which articles are clipped from which types of users; and
(h) allowing for a central transaction clearinghouse for articles that will collect money from users and then, after taking a fee, compensate the original publishers—by which method users can avoid registering at many different web sites.

10. A process for storing and accessing information from publisher's server storage electronically, comprising:
(a) providing each media article with an alphanumeric code having regions in the code for publication source, publication date, article identification;
(b) caching each article using the code as a local file identifier in a relational database management system (RDMS) table; and
(c) associating the code with each article published to allow for retrieval of the article through accessing the table.

11. The process for storing and accessing information from publisher's server storage electronically of claim 10, wherein the alphanumeric code is from about 7 to about 20 digits in length.

12. The process for storing and accessing information from publisher's server storage electronically of claim 10, wherein the alphanumeric code is printed or affixed to each article contained in the table.

13. The process for storing and accessing information from publisher's server storage electronically of claim 10, wherein the RDMS is arranged to allow for article retrieval by addressing through the article's alphanumeric code.

14. The process for storing and accessing information from publisher's server storage electronically of claim 10, wherein each article having the alphanumeric code is identified in a single table and is accessible through a common link.

15. The process for storing and accessing information from publisher's server storage electronically of claim 10, wherein the process further comprises creating a retrieval website that assesses a fee to users for each article accessed from the cache and searched through the alphanumeric code.

16. The process for storing and accessing information from publisher's server storage electronically of claim 10, wherein the process further comprises configuring the retrieval website to provide for targeted advertising.

17. The process for storing and accessing information from publisher's server storage electronically of claim 10, wherein the retrieval website tracks articles accessed to provide for a copyright fee to each publisher whose article was copied, from the fee charged to the user.
